(19) United States
(12) Patent Application Publication
(10) Pub. No.: US 2004/0204180 A1
(43) Pub. Date: Oct. 14, 2004

(54) Cellular phone with built-in generator

(76) Inventor: Ming-Zhen Liao, Yunlin (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/287,648

(22) Filed: Nov. 5, 2002

(51) Int. Cl. H04B 1/38

(52) U.S. Cl. 455/573; 455/550.1

(57) ABSTRACT

A built-in hand operatable generator for a cellular phone is provided. This generator can either be a DC or a AC dynamo equipped with a hand turning wheel or a hand operated crank emerged out of the cellular phone housing. This generator supplies the power to a charging circuit by rotating the wheel or the crank with hand so as to replenish electricity into the rechargeable dry battery of the phone in time of need.

### BACKGROUND OF THE INVENTION

1. Field of the Invention

The present invention relates to a cellular phone with built-in generator, and more particularly, to a cellular phone equipped with a small hand operated generator so as to supply electricity to the cellular phone any time at any place.

2. Description of the Prior Art

For years a cellular phone has become one of personal electronic necessities because important and timely communications can be carried out in time of need among places for away apart.

However, there is a hot problem remains to be solved, that is replenishment of electricity, the working energy, to keep the cellular phone reliably usable at all times. A tiny battery accommodated in limited space of a compact cellular phone is certainly unable to store sufficient energy to last satisfactorily for a long time. Normally, the capacity of an average cellular phone battery can only allow several hours working. Consequently, the owner of the cellular phone should always keep in mind to replace his/her phone's battery from time to time so as to keep his/her cellular phone in a normally usable state in order not to make the phone fall into disable state or interrupt the communication in the crucial time. Although a rechargeable battery may be used, yet an AC charging source usually can not be found just timely in urgent need.

In order to eliminate the inconvenience inherent to the conventional technique as mentioned above, the inventor of the present invention thinks it is a must that a cellular phone to accompany an electrical power source which can supply power in time of need so as to keep the cellular phone always in the workable condition. This ideal has been realized by a cellular phone with built-in generator of the present invention through consistent effort for years.

### SUMMARY OF THE INVENTION

It is an object of the present invention to provide power generating means in the cellular phone which can replenish the phone with the consumed energy so as to keep the phone always in workable condition.

It is another object of the present invention that this power generating means is handy, compact, and able to be installed in a limited accommodation space in a conventionally constructed cellular phone.

To achieve the above mentioned object, the present invention provides a built-in hand operatable generator accommodated in the cellular phone, this generator can either be a DC or a AC dynamo type generator equipped with a hand turning wheel or a hand operated crank emerged out of the cellular phone housing. This DC or AC generator supplies the power to a charging circuit by rotating the wheel or the crank with hand so as to replenish electricity into the rechargeable dry battery of the cellular phone in time of need, and keep the phone always in a workable condition.

### BRIEF DESCRIPTION OF THE DRAWINGS

For fuller understanding of the nature and objects of the invention, reference should be made to the following detailed descriptions taken in conjunction with the accompanying drawings in which:

FIG. 1 is a block diagram illustrating the construction of the present invention;

FIG. 2 is a schematic view illustrating the structure of the built-in generator according to the present invention;

FIG. 3 is a schematic view of the hand turning wheel for the built-in generator according to the present invention; and

FIG. 4 is a schematic view of the hand operated crank for the built-in generator according to the present invention.

### DETAILED DESCRIPTION OF THE PREFERRED EMBODIMENT

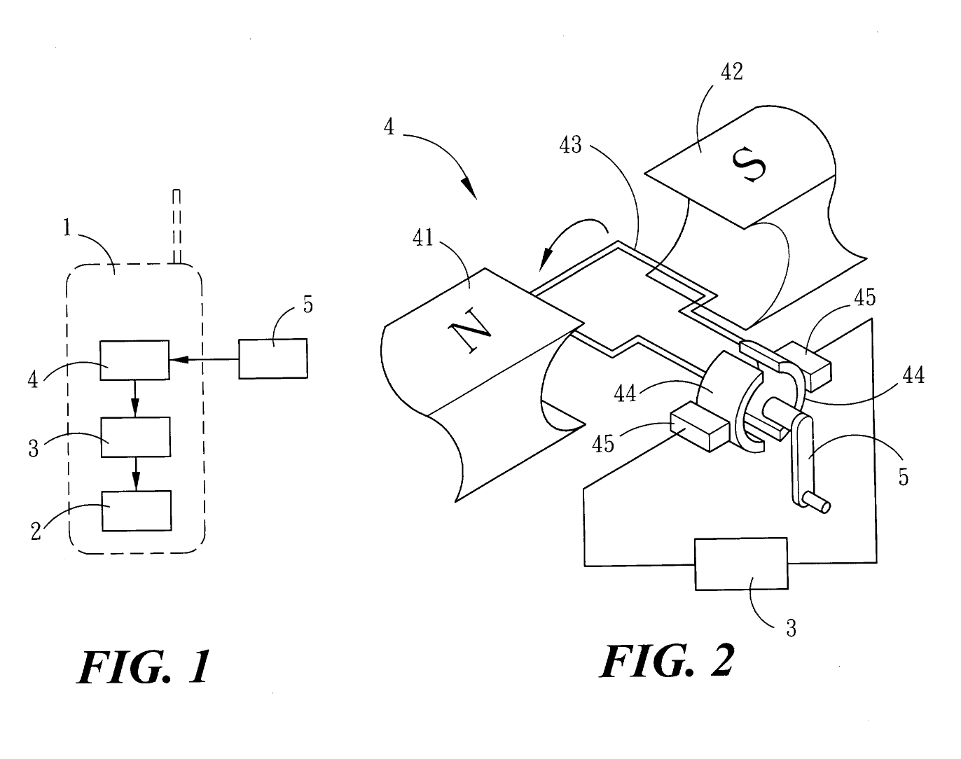

Referring to FIG. 1, the cellular phone 1 used in the present invention is a conventional one in which a rechargeable battery 2 is contained. The charging operation is carried out by connecting the battery 2 to a charging circuit 3 which is further connected to an outer power supply source. However, in the present invention, a hand turning generator 4 is equipped in the cellular phone 1 in stead of connecting the charging circuit 3 to the outer power source. A operating shaft 5 of the generator 4 is stretched out of the housing of the cellular phone 1 for the phone user to drive the generator to generate the electrical power which is then charged into the battery 2 via the charging circuit 3.

Referring to FIG. 2, the hand turning generator 4 is a bipolar DC dynamo which contains a pair of permanent magnets N-pole 41 and S-pole 42, and a rotating element called an armature core with winding 43 thereon located in the magnetic field built up by the pair of magnets 41, 42. The terminal conductors of the armature winding 43 are connected to a pair of semi-circular commutator segments 44 each of which is further in contact with a brush 45. The DC current drawn out from the generator 4 by the brushes 45 is conducted to the charging circuit 3 for supplying the battery 2 with the DC charging current. The above mentioned DC generator 4 may be replaced by an AC generator, in this case an extra rectifier circuit has to be provided for converting generator AC output to the charging circuit DC input. As for how to obtain DC power from the generator 4 belongs to a well known basic principle of DC machinery hence it will not be illustrated herein.

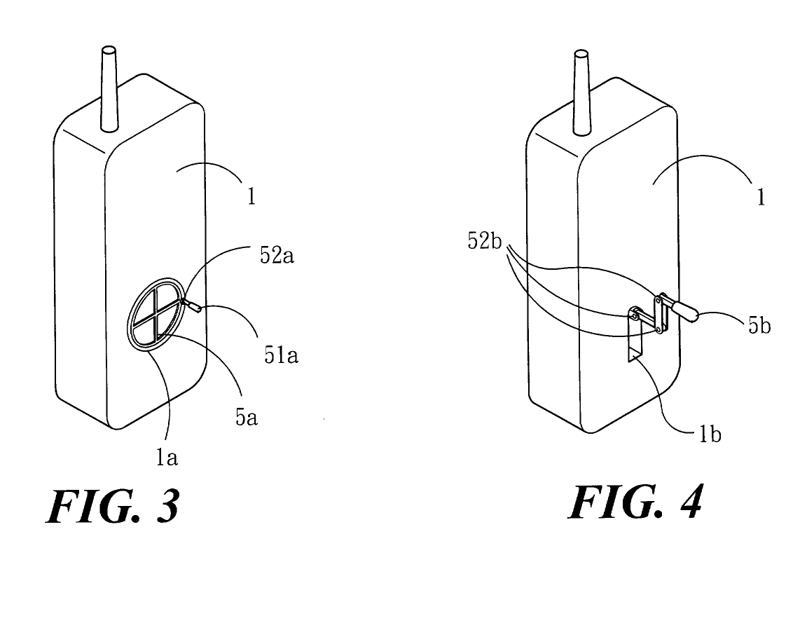

Referring to FIG. 3, the operating shaft 5 of the hand turning generator 4 may be formed into a wheel 5a with a shank 51a affixed to its circumference thereof to manually turn the wheel 5a by hand thereby actuating the generator 4. For the sake of giving a better appearance for the cellular phone 1, a recessed accommodation space 1a is formed on the wheel surface which keeps flush with the housing surface of the phone 1. An articulation joint 52a is formed at the junction of the shank 51a and the wheel 5a such that the shank 51a is collapsible to put away in the accommodation opace when not in use.

Referring to FIG. 4, the operating shaft may be a hand operated crank 5b. Several articulations 52b on the crank 5b for folding it into several short sections, and putting away in an accommodation space 1b are provided on a certain relevant position on the phone housing. In this version the outer appearance of the cellular phone 1 can be maintained neat and orderly.

Other conventional and equivalent structures to the wheel 5a and the hand operating cranks can be adopted as variation to the operating shaft to drive the generator of the present invention.

From the above description, it is understood that the cellular phone provided with the built-in generator of the present invention can keep the phone power source always in a reliable state to make the communication without the fear of unexpected interruption. Adding of this built-in generator into a conventional cellular phone needs only an increase of a little production cost but will be rewarded a lot later on.

Those who are skilled in the art will readily perceive how to modify the invention. Therefore, the appended claims are to be construed to cover all equivalent structures which fall within the true scope and spirit of the invention.

What is claimed is:

1. A cellular phone with built-in generator containing a rechargeable battery, a charging circuit, and a hand turning generator with an operating shaft stretched out of the housing of said cellular phone, wherein the output terminals of said generator are connected to said charging circuit thereof.

2. The cellular phone with built-in generator of claim 1, wherein said operating shaft is formed into a wheel with a shank affixed to its circumference thereof, and an articulation joint is formed at the junction of said shank and said wheel such that said shank is collapsible thereat.

3. The cellular phone with built-in generator of claim 1, wherein said operating shaft is a hand operated crank, and several articulations are formed on said crank for folding it into several short sections to minimize its size.

4. The cellular phone with built-in generator of claim 1, 2 or 3, wherein an accommodation space is provided on said phone housing to put away said operating shaft.
